(19) United States
(12) Patent Application Publication
(10) Pub. No.: US 2004/0226417 A1
(43) Pub. Date: Nov. 18, 2004

(54) Wing tip wrench adapter

(76) Inventor: Norbert Kirk, Sun City, AZ (US)

Correspondence Address: George H. Miller Jr., 2936 Miller Hts. Rd., Oakton, VA, 22124, US

(21) Appl. No.: 10/436,994

(22) Filed: May 14, 2003

(51) Int. Cl. B25B 23/16

(52) U.S. Cl. 81/177.4

(57) ABSTRACT

A wing tip wrench adapter to be inserted into a wrench opening that can be provided in a series of four, five, six or more adapters, and stored on the handle of a wrench that can receive the adapters to provide a unitized wrench that can handle a variety of nut sizes.

### BACKGROUND OF THE INVENTION

Wrenches have been developed over the years in many configurations based upon certain desirable features such as leverage, compactness and variety of applications. It has been common to design wrenches in a single unit to have several openings for different sized nuts or to have individual wrap around sockets that can be locked into an opening in a leverage bar.

In U.S. Pat. No. 384,043 issued to Kiblinger in 1888, a screw driver has an attachment in the form of an awl on the tool shaft that can be moved down and used to drill a hole so that the screw driver can then secure a screw in the hole.

In U.S. Pat. No. 3,802,303 issued to Evans et al in 1974, an open end wrench, shown in FIG. 2, can receive a plurality of metallic inserts to adapt the wrench for operation in tightening or loosening any of a plurality of standardized nut sizes.

In U.S. Pat. No. 4,620,460 issued to Gonzales Jr. in 1986, a socket set comprises a series of six sockets extending from a screw driver type handle, each socket axially inserted into a preceding one to achieve the smallest socket on the tip. To use the next larger socket on a larger nut, lower sockets are removed.

In U.S. Pat. No. 4,798,111 issued to Cheeseman in 1989, a stacking socket wrench similar to Gonzales Jr. uses a series of sockets with central holes in them to receive the handle shaft down to the lowest socket. All sockets are used with the required size positioned as the last one and the others positioned above it on the handle shaft.

In U.S. Pat. No. 4,882,958 issued to McNeely in 1989, a stacking socket wrench similar to Gonzales Jr. uses a series of sockets with central holes in them to interface with and secure nuts on long bolts as shown in FIG. 7 of McNeely.

It is an object of the current invention to provide improvements over the above five inventions that result in a compact, easy to use wrench that can be used in a variety of situations. It is believed that the novelty lies in a socket adapter that can be used in a variety of wrenches with open or closed sockets. A series of adapters can be secured by spring action for easy removal and replacement on the handle to provide a similar type improved storage and function as is provided in the above wrenches to Evans, Gonzales Jr., Cheeseman and McNeely.

### SUMMARY OF THE INVENTION

This invention will comprise two embodiments that can be applied to a series of wrench opening adapters to provide a sequential series of standard fittings for standard nut sizes to be tightened or loosened.

### BRIEF DESCRIPTION OF THE DRAWINGS

FIG. 1 is a first embodiment of a single piece wrench adapter of U-shape using a metal strip of a fixed thickness for a certain nut size.

FIG. 2 is a second embodiment of a wrench adapter of U-shape using two pieces of a metal strip with a selected metal sleeve thickness to achieve a fixed thickness for a certain nut size.

FIG. 3 shows a bottom view of the adapter of FIG. 1 with a hole in the center to accommodate bolts with long stems.

FIG. 4 shows a screw driver type wrench with a shaft to receive five adapters.

FIG. 5 shows an adapter inserted in the opening of the wrench of FIG. 3 for use on a nut.

FIG. 6 shows a wrench with an open end and with a closed socket end.

FIG. 7 shows an L-shaped wrench, commonly used for loosening/tightening the nuts on wheels on cars.

FIG. 8 shows a closed socket for use with an attachable handle.

### DETAILED DESCRIPTION OF THE INVENTION

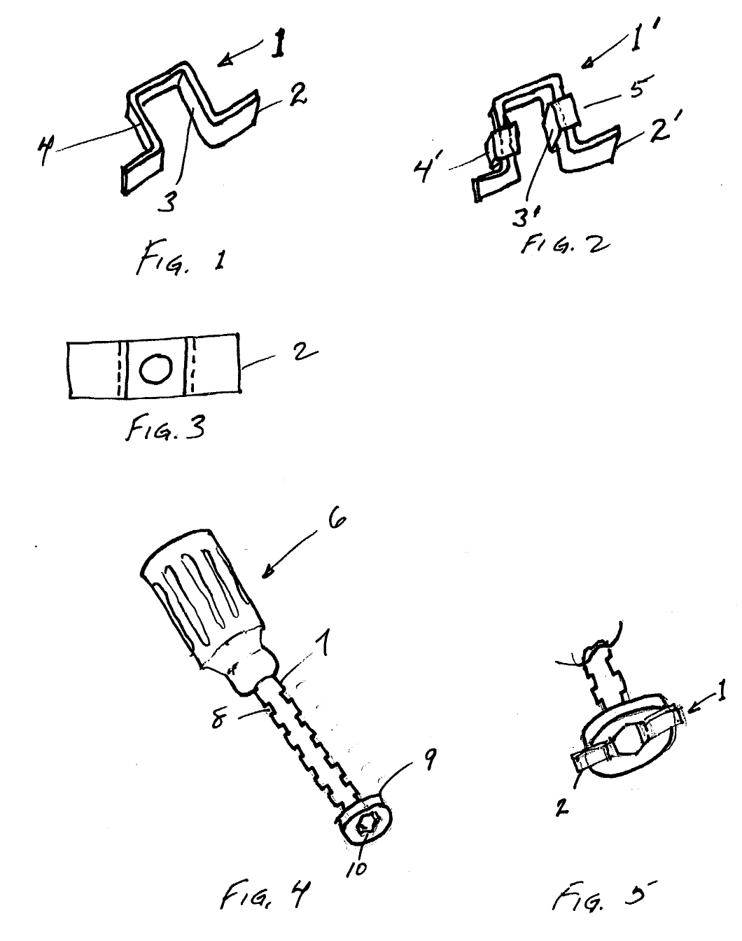

A first embodiment single piece wrench adapter 1 as shown in FIG. 1 comprises a narrow strip of steel bent into a U-shape with a wing tips 2 projecting from each side. The thickness of the narrow strip of steel can be varied but the external width of the external sides 4 of the U-shape must be the same for a series of adapters to fit into a polygonal opening with two opposing sides to interface with the two sides of the U-shape. The variances in the thicknesses with the fixed U-shape width provides a variance in the internal sides 3 of the U-shape which is where a nut is engaged for loosening or tightening. The wing tips 2 should be of such a length as to extend beyond the outer edge of the opening into which the adapter is inserted.

A second embodiment two piece wrench adapter 1′ is shown in FIG. 2 and comprises a narrow strip of steel bent into a U-shape with a wing 2′ projecting from each side. The thickness of the narrow strip of steel can be fixed for a series of adapters to fit into a polygonal opening but the width of the external sides 4′ of the U-shape will be varied. Rectangular sleeves 5 around each side of the U-shape will vary in thickness to achieve a compensating thickness to make the external width of the U-shape the same as in the first embodiment. The variances in the thickness of the rectangular sleeve also provides a variance in the internal sides 3′ of the U-shape which is where a nut is engaged for loosening or tightening.

FIG. 3 shows a bottom view of the adapter of FIG. 1 with a hole in the center to accommodate bolts with long stems. The bottom face interfaces with a bolt that has the nut to be tightened or loosened and the hole can also provide increased resilience to the two sides when the adapter is placed back on the shaft of a wrench on which it is stored.

The wrench openings into which the adapter is inserted can be any polygonal shape that provides opposite sides to mate with the external sides of the U-shape. Hexagonal may be the most common. Open ended wrenches provide two opposed sides connected by a curved surface. Some closed end wrenches provide a series of sixteen to twenty four teeth to mate with a variety of polygonal shapes. The adapter can be dimensioned to be inserted into any of these selected openings.

FIG. 4 shows a screw driver type wrench 6 with a shaft 7 with six indentations 8 of varying depth on opposite sides of shaft 7 to receive and store six adapters that can fit into hexagonal opening 10 of socket 9.

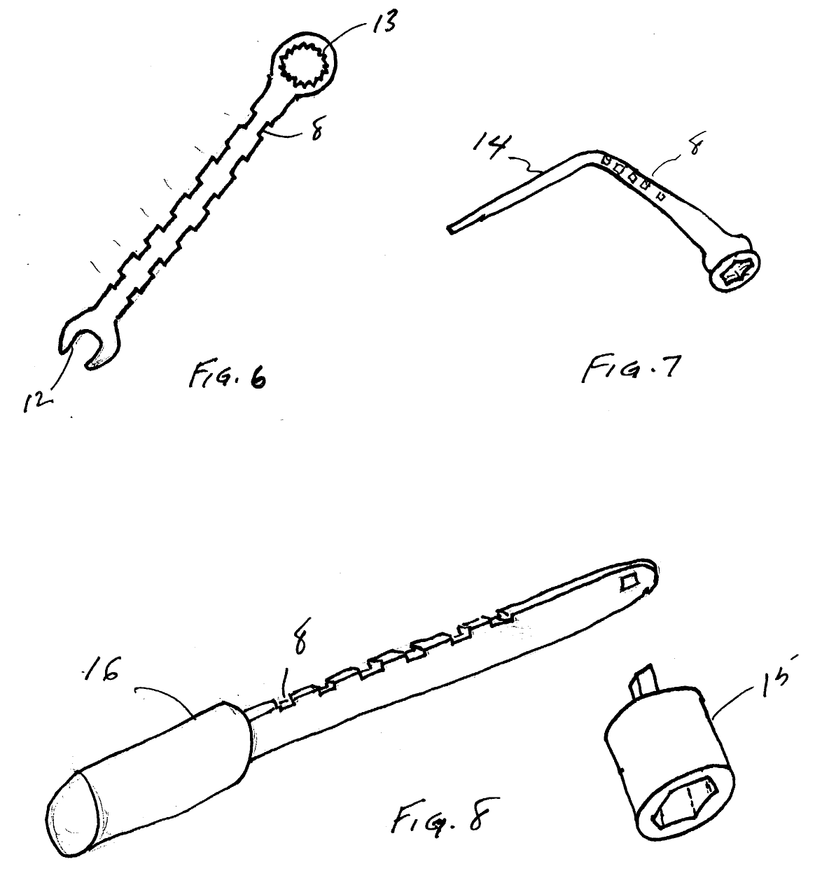

FIG. 5 shows an adapter 1 inserted into socket 9 with the wing tips 2 extending beyond the outer edge of the opening.

FIG. 6 shows a conventional wrench with an open end 12 and with a closed socket end 13 and with six indentations 8 of varying depth on opposite sides of the shaft to receive and store six adapters that can fit into either open end 12 or closed socket 13.

FIG. 7 shows an L-shaped wrench with a closed socket, commonly used for loosening/tightening the nuts on wheels on cars. The handle portion 14 can have six indentations of varying depth on opposite sides of the shaft to receive and store six adapters as shown in FIG. 5.

FIG. 8 shows a closed socket 15 for use with an attachable handle 16. The attachable handle 16 could have six indentations of varying depth on opposite sides of the shaft to receive and store six adapters as shown in FIG. 6.

The indentations 8 to store the adapters on the handles and shafts referred to above are to be varied in depth to receive the various sized adapters with a slight spring connection to secure the adapters to a selected handle or shaft. The wing tips provide increased leverage for placing or removing the adapters and make it easy to remove them from the wrench sockets.

Modifications of the above adapter may be effected by variances in dimensions to fit wrenches with open ends and with closed sockets. The term “socket” can also be considered as applying to an open ended wrench. The number of adapters stored on a handle can also be varied from five to fewer or more adapters.

What is claimed is:

1) A wrench adapter dimensioned to fit into an open ended wrench or closed end wrench comprising a U-shape with wing tips that can be varied in thickness to provide an internal width between the sides of the U-shape to fit a standard nut size.

2) A two piece wrench adapter dimensioned to fit into an open ended wrench or closed end wrench comprising a U-shape with wing tips and a sleeve on each side of the U-shape to provide a width on the outer sides of the U-shape to fit into an open ended wrench or closed end wrench and to provide an internal width between the sides of the U-shape to fit a standard nut size.

3) An adapter as in claim 1 or 2 with a hole in the bottom of the U-shape to provide clearance for contacting nuts on bolts with long stems.

4) A series of four or more adapters as in claim 1 or 2 secured to the handle of a screw driver type wrench with a shaft containing opposed indentations to receive the adapters.

5) A series of four or more adapters as in claim 1 or 2 secured to the handle of an L-shaped handle containing opposed indentations to receive the adapters.

6) A series of four or more adapters as in claim 1 or 2 secured to a detachable handle that can be secured to a socket with an opening to receive an adapter, the handle containing opposed indentations to receive the adapters.
